(19) United States
(12) Patent Application Publication
(10) Pub. No.: US 2015/0306497 A1
(43) Pub. Date: Oct. 29, 2015

(54) Systems and Methods of Electronic Equipment Regulation

(71) Applicant: Raven SAMPSON, (US)

(72) Inventor: Raven SAMPSON, Cumming, GA (US)

(21) Appl. No.: 14/647,682

(22) PCT Filed: Nov. 27, 2013
(86) PCT No.: PCT/US13/72181

§ 371 Date: May 27, 2015

Related U.S. Application Data
(60) Provisional application No. 61/730,389, filed on Nov. 27, 2012.

(51) Int. Cl. A63F 13/23

(52) U.S. Cl. CPC A63F 13/23

(57) ABSTRACT

Example embodiments of the systems and methods of electronic equipment regulation disclosed herein include a smart box. The smart box may be enabled through various combinations of hardware and software, including only hardware and only software. Example embodiments of the smart box may incorporate an adapter that connects to a gaming console or other electronic equipment. The smart box may stop the flow of the game to the television and begin the educational program, which may be set/determined by an administrator. Example embodiments may, as non-limiting examples, connect to the console in the back of the console via an HDMI/Audio Video cable and via the front of the console through the controller ports, which will allow the smart box to interrupt or pause the feed of the game. It may pause the game or only interrupt the video output, among other implementations.

### CROSS-REFERENCE TO RELATED APPLICATION

This application claims priority to PCT Application Serial No. PCT/US13/72181, filed on Nov. 27, 2013, which claims benefit to U.S. provisional patent application Ser. No. 61/730,389, filed on Nov. 27, 2012, which is incorporated by reference herein.

### TECHNICAL FIELD

The present disclosure is generally related to game systems and, more particularly, is related to regulating the use of the gaming systems.

### BACKGROUND

Although the first video games appeared in the 1950s, they were played on vector displays connected to massive computers, not analog televisions. Ralph H. Baer conceived the idea of a home video game in 1951. In the 1960s he created a working video game console at Sanders Associates, but struggled for years to find a television manufacturer willing to produce the console.

In 1972, Magnavox released the Magnavox Odyssey, the first home video game console which could be connected to a TV set. Ralph Baer's initial design had called for a huge row of switches that would allow gamers to turn on and off certain components of the console (the Odyssey lacked a central processing unit) to create slightly different games like tennis, volleyball, hockey, and chase. Magnavox replaced the switch design with separate cartridges for each game. Although Baer had sketched up ideas for cartridges that could include new components for new games, the carts released by Magnavox all served the same function as the switches and allowed gamers to choose from the Odyssey's built in games.

The Odyssey was initially only moderately successful, and it was not until Atari's arcade game Pong popularized video games, that the public began to take more notice of the emerging industry. By the autumn of 1975 Magnavox, bowing to the popularity of Pong, cancelled the Odyssey and released a scaled down version that played only Pong and hockey, the Odyssey 100. A second, “higher end” console, the Odyssey 200, was released with the 100 and added onscreen scoring, up to four players, and a third game—Smash. Almost simultaneously released with Atari's own home Pong console through Sears, these consoles jump-started the consumer market. All three of the new consoles used simpler designs than the original Odyssey with no board game pieces or extra cartridges.

In the years that followed, the market saw a multitude of companies rushing similar consoles to market. After General Instrument released their inexpensive microchips, each containing a complete console on a single chip, many small developers began releasing consoles that looked different externally, but internally were playing exactly the same games.

The consoles from this era were mostly dedicated consoles playing only the games that came with the console. These video game consoles were often just called video games, because there was little reason to distinguish the two yet. While a few companies like Atari, Magnavox, and newcomer Coleco pushed the envelope, the market became flooded with simple, similar video games. Video games have been available to consumers for the last 30 years. They are a unique form of entertainment, because they encourage players to become a part of the game's script. Today's sophisticated video games require players to pay constant attention to the game, rather than passively watching a movie. This has both positive and negative impacts on players. Several studies have been published that explore these impacts on today's children. The most widely used “positive” impact video games are said to have on children is that they may improve a player's manual dexterity and computer literacy. Ever-improving technology also provides players with better graphics that give a more “realistic” virtual playing experience.

This quality makes the video game industry a powerful force in many adolescent lives. However, numerous studies show that video games, especially ones with violent content, make teens more aggressive. Part of the increase in aggressive behavior is linked to the amount of time children are allowed to play video games.

In one study by Walsh (2000), a majority of teens admitted that their parents do not impose a time limit on the number of hours they are allowed to play video games. The study also showed that most parents are unaware of the content or the Entertainment Software Rating Board (ESRB) rating (see below) of the video games their children play.

In another study—conducted by Gentile, Lynch, Linder & Walsh (2004, p. 6)—“adolescent girls played video games for an average of 5 hours a week, whereas boys averaged 13 hours a week.” The authors also stated that teens who play violent video games for extended periods of time tend to be more aggressive, are more prone to confrontation with their teachers, may engage in fights with their peers, and see a decline in school achievements. (Gentile et al, 2004).

The interactive quality of video games differs from passively viewing television or movies because it allows players to become active participants in the game's script. Players benefit from engaging in acts of violence and are then able to move to the game's next level.

Gentile & Anderson (2003) state that playing video games may increase aggressive behavior because violent acts are continually repeated throughout the video game. This method of repetition has long been considered an effective teaching method in reinforcing learning patterns.

Video games also encourage players to identify with and role play their favorite characters. This is referred to as a “first-person” video game (Anderson & Dill, 2000, p. 788) because players are able to make decisions affecting the actions of the character they are imitating.

After a limited amount of time playing a violent video game, a player can “automatically prime aggressive thoughts” (Bushman & Anderson, 2002, p. 1680). The researchers concluded that players who had prior experience playing violent video games responded with an increased level of aggression when they encountered confrontation (Bushman & Anderson, 2002).

In a Joint Statement (2000) before the Congressional Public Health Summit, a number of American medical associations—the American Medical Association, American Academy of Pediatrics, American Psychological Association, American Academy of Family Physicians, and American Academy of Child & Adolescent Psychiatry—caution parents about violence in the media and its negative effect on children.

Their report states that exposure to violent media can elevate aggressive feelings and thoughts, especially in children. These effects on aggressive behavior can be long-term. Although fewer studies have been conducted on interactive video games, evidence suggests that playing violent video games may have a more dramatic influence on the behavior of children and adolescents (Joint Statement, 2000). There are heretofore unaddressed needs with previous solutions in limiting the time that children play video games.

### SUMMARY

Example embodiments of the present disclosure provide systems of electronic equipment regulation. Briefly described, in architecture, one example embodiment of the system, among others, can be implemented as follows: a smart module comprising a processor configured: to interface with electronic equipment; to present a task to a user of the electronic equipment; and to prevent use of the electronic equipment until the task is completed.

Embodiments of the present disclosure can also be viewed as providing methods for electronic equipment regulation. In this regard, one embodiment of such a method, among others, can be broadly summarized by the following steps: preventing use by a user of electronic equipment; presenting a task to the user; and allowing use by the user of the electronic equipment only after an acceptable completion level of the task has been reached.

### BRIEF DESCRIPTION OF THE DRAWINGS

FIG. 1 is a system diagram of an example embodiment of electronic equipment used by a user.

FIG. 2 is a system diagram of an example embodiment of a system of electronic equipment regulation.

FIG. 3 is a system diagram of an example embodiment of a system of electronic equipment regulation.

FIG. 4 is a block diagram of an example embodiment of the smart box of FIG. 2 and FIG. 3.

FIG. 5 diagram of a screen display of the example embodiment of the system of electronic equipment regulation of FIG. 2 and FIG. 3.

FIG. 6 is a flow diagram of an example embodiment of a method of electronic equipment regulation.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Example embodiments of the systems and methods of electronic equipment regulation disclosed herein include a smart box which may be employed to help further the education of today's youth. Children may spend countless hours a week playing video games. Example embodiments of the smart box system may not only stop the amount of time gaming, but also incorporate education into the process so a user can continue to learn as he/she plays the game. The benefits may be introduced as the youth is engaged in the various games and various questions are incorporated periodically through the game to motivate the player to think through the problem introduced in the question so that he/she may quickly move back to the game. Example embodiments of the smart box may continue to enforce learning in an engaging, fun environment.

The smart box may be enabled through various combinations of hardware and software, including only hardware and only software. Example embodiments of the smart box may incorporate an adapter that connects to a gaming console or other electronic equipment, such as but not limited to Nintendo GameCube, Xbox, Xbox 360, Xbox One, Wii, Wii U, PlayStation, PlayStation 2, PlayStation 3, and Playstation 4, among others. The smart box may stop the flow of the game to the television and begin the educational program, which may be set/determined by an administrator. The device may have its own power adapter or may run off of the power of the gaming console. Example embodiments may, as non-limiting examples, connect to the console in the back of the console via an HDMI/Audio Video cable and via the front of the console through the controller ports, which will allow the smart box to interrupt or pause the feed of the game. It may pause the game or only interrupt the video output, among other implementations.

In a multi-player on-line live game example, the character of the player controlled by the smart box will be paused, but the remainder of the game and its characters continues. No other characters are affected by the player. In an example embodiment, the personal gaming controllers used by players to control the game may plug into the smart box instead of the gaming console. In an example embodiment, the software will be fed into the smart box by a programmed and interactive DVD. In an alternative embodiment, the software may be installed as firmware on the smart box, be installed through a USB enabled thumb drive, on a memory card, or other memory device. The software may also be downloaded over the internet, through a Wi-Fi connection, and through a Bluetooth connection as non-limiting examples. In an alternative embodiment, the smart box functionality may be integrated within the gaming system software and/or hardware itself.

In an example embodiment, an administrator initially sets up the smart box. The administrator may set up one or more of the following non-limiting criteria: password, timing consequences, and reporting, among others. In an example embodiment, an administrator sets up a password. The password may be input through a keypad on the external surface of the smart box, through a software interface through the game, wirelessly, biometrically, or through any other input means. The password may be changed as often as desired. Any or all settings may require the password to be updated. The password may be required to be updated periodically, and the update period may or may not be configurable by the administrator.

In an example embodiment, the administrator determines the timing of how frequent the questions are to be generated. The questions may be generated every 5 minutes, for example. In an alternative embodiment, the questions are generated every time the user reaches a particular or subsequent level, score, or position in the game.

In an example embodiment, the administrator determines the consequences if the player misses the question. In a first non-limiting example, the smart box generates an “Incorrect” graphic or text message and asks another question. In a second non-limiting example, the smart box causes the game to be exited without saving the game's progress (if optional) after a predetermined number of wrong answers. In a third non-limiting example, the game's progress is saved up to that point after a predetermined number of wrong answers. The predetermined number of wrong answers may be configurable by the administrator.

In an example embodiment, an administrator sets up the smart box for reporting options. This feature may allow the administrator to determine where the user is struggling and at that point can determine how to help the user. In an example embodiment, a report is automatically generated and may be stored on the smart box for viewing the results of the player's responses to the questions. Stored reports may be automatically deleted after one week, as a non-limiting example. If the smart box is connected to a network, such as the internet, the administrator may set up the option to have the report sent directly to an email address (which may be set up in administrator settings).

In an example embodiment, the smart box software may be created to pause the player's game for interruption and for initiation of the software. Once the game has paused, the software may begin a series of questions (for example, determined by the administrator's settings). If the question is answered correctly, the game may resume in an example embodiment. Alternatively, a predetermined number of questions may need to be answered correctly before play may be resumed. The administrator may set criteria which must be met before play may be resumed. In the case of educational question, the criteria may include answering a particular percentage of the questions correctly. In an alternative embodiment in which a particular task may be completed, some proof that the task (such as non-limiting examples of washing of the dishes, performing certain exercises, raising the heart rate, etc.) may have to be proven before play may be resumed.

In an example embodiment, if the question is answered incorrectly, the options vary as to what will occur next (see administrator settings). In an example embodiment, the software is an educational based program and may be set up by grade levels. It may be configured to incorporate one or more of the major subjects, such as Math, Literature, Science, etc. It may also be configured to incorporate specialized courses such as Latin, Home Economics, and Theology, for example. Alternatively, the questions may be more refined by grade and subject level. For instance, if a player is in the 10th grade and struggling with chemistry, for example, the parent may purchase a 10th grade level chemistry software package.

An additional feature may allow the questions to be entered manually accommodating specific tests prep questions for upcoming tests. In an example embodiment, the smart box uses an internet connection and may include an additional monthly fee for the added support and features. The administrator may initially setup a username and password for the account. An example embodiment may allow the administrator to contact a central smart box server and direct certain questions to be inserted into a database for circulation that week. Alternatively the administrator may insert the questions/answers manually, for example, directly through the smart box interface, through an internet connection to the central server, wirelessly to the smart box, etc.

Example embodiments of the smart box can be used for alternate uses, such as software packages designed to be used for ACT, SAT, and PSAT practices. Packages may be created to help increase the knowledge of the Bible.

Alternative embodiments may incorporate additional items, such as a watch or band, for the user to wear to monitor the heart rate. Instead of questions, it may require an increase in physical activity to help reduce inactivity and lower obesity, which is an American epidemic in today's youth. The interface between the additional item, may be one of many non-limiting methods, including Bluetooth, wireless LAN, IR, near field communication, inductive coupling, etc.

The smart box may also add a marketing aspect, which includes the following additional components and are geared for the sole purposes of increasing marketing visibility thus increasing revenue and promoting incentives by educational contests for all youth involved in playing the smart box configured gaming console to encourage the desire to solve the smart box questions correctly.

The advertising may target specific companies and promote marketing options by increasing visibility to their brand for all youth or for a specified target group. The company's ad campaign may be promoted on the screen (such as the gaming display, a smart box display, or some other method) with the questions. For example, “Questions brought to you by Mattel” may be displayed before the educational question appears. Additionally, an advertisement may be displayed at the beginning of the smart box startup. In an example embodiment, a profile may be set up to “Skip Ad” similar to many advertising schemes in the computer industry.

Each profile may be setup differently allowing each child/user's information to determine what grade level CD is best for him/her. The same profile may be used to determine what likes/dislikes may be complimented with the specific offers/advertisements selected to be used with the smart box system. The question/answer (the educational questions) selection may remain the same; however, each child may have a specific series of randomized marketing campaigns running simultaneously, increasing the volume of marketing campaigns running.

Although the systems and methods of electronic equipment regulation provided herein are generally shown for use with a gaming console, the smart box may also be used with smart TVs, tablets, laptops, desktops, hand held games, and smart phones among other electronic equipment. Although described as an add-on module, the smart box may also be embodied in a smart chip, software, or a combination of hardware and software, internal to the game systems, such as the PlayStation Portable (PSP), GameBoy, Nintendo DS and even MP3 and MP4 players, including IPODS, among others. Example embodiments of the smart box and smart chip may also be applied to computers as well.

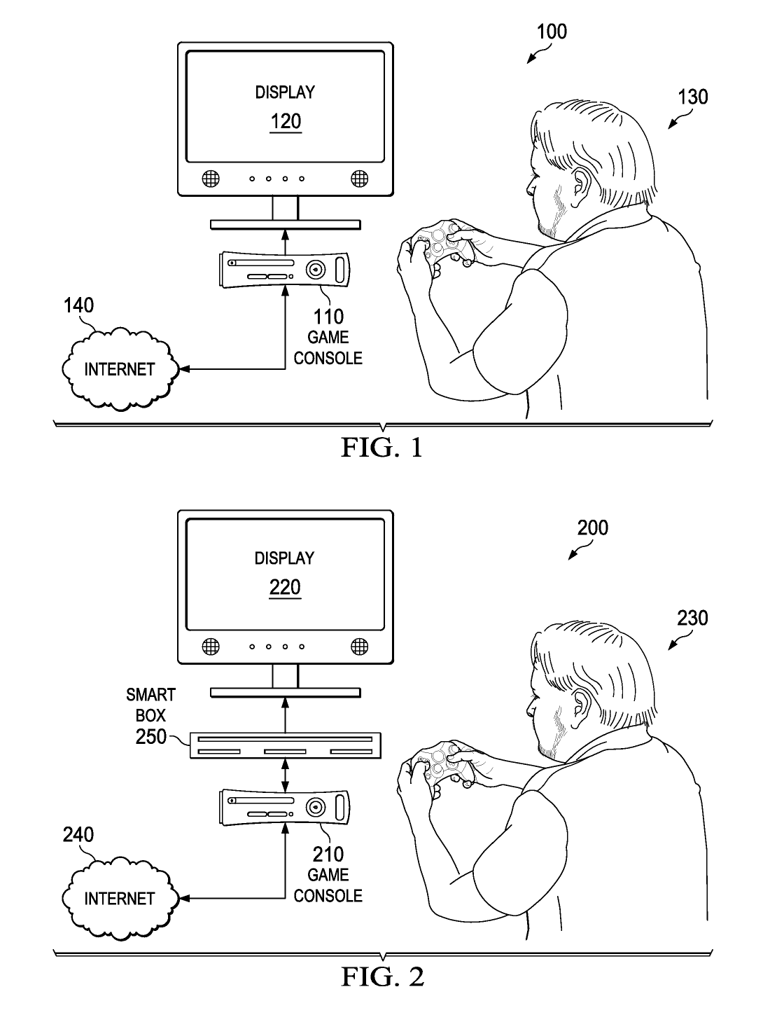

FIG. 1 provides system diagram 100 of an example embodiment of user 130 with typical gaming system or game console 110. Game console 110 presents the video output on display 120. User 130 may use a wireless or wired controller to interface with game console 210. Game console 110 may be connected to Internet 140 or it may be played off-line. Typical game consoles include Xbox, Sony PlayStation, and Nintendo Wii. Although the figures show a game console being used, example embodiments may also be applied to a personal computer, a laptop, a tablet, and a smart phone, among other electronic equipment.

FIG. 2 provides system diagram 200 of an example embodiment of user 230 with game console 210 and video output 220. User 230 controls game console 210 with a controller which may be connected to game console 210 either wirelessly or through a wired connection. Game console 210 may be connected to the Internet or other network. Smart box 250 may also be connected to the same or different network as game console 210. In this example embodiment, smart box 250 is connected between game console 210 and display 220. At a time configurable by an administrator, smart box 210 interrupts the video feed between game console 210 and display 220 and presents a task to user 230.

In an example embodiment, the task comprises a list of questions that are related to a particular subject that the user is learning in school. In an alternative embodiment, the task may be to wash the dishes or perform some aerobic activity. The completion of the task may be accomplished by various means and checked against a completion criteria. The completion criteria may comprise an acceptable percentage of questions answered correctly, a number of questions answered correctly, the dishwasher turned on, and a heart rate level reached, among other non-limiting examples. The task to be completed may be accessed through Internet 240 or may be stored in memory on smart box 250, among other non-limiting examples.

In the example embodiment of FIG. 2, smart box 250 is connected between game console 210 and display 220. In an example embodiment, the play of user 230 is halted, for example, by sending a signal from smart box 250 to game console 210 and causing game console 210 to perform at least one of pausing the activity of user 230 on game console 210 and pausing the video output on display 220 without pausing the activity on game console 210.

In an example embodiment, the controller is connected to smart box 250. A special controller is used that only works through gaming console 250 and does not interface directly with game console 210. If the user unplugs smart box 250, the controller no longer works and game console 210 is unusable. Alternatively, Game console 210 may configured such that it is only usable if smart box 250 is connected.

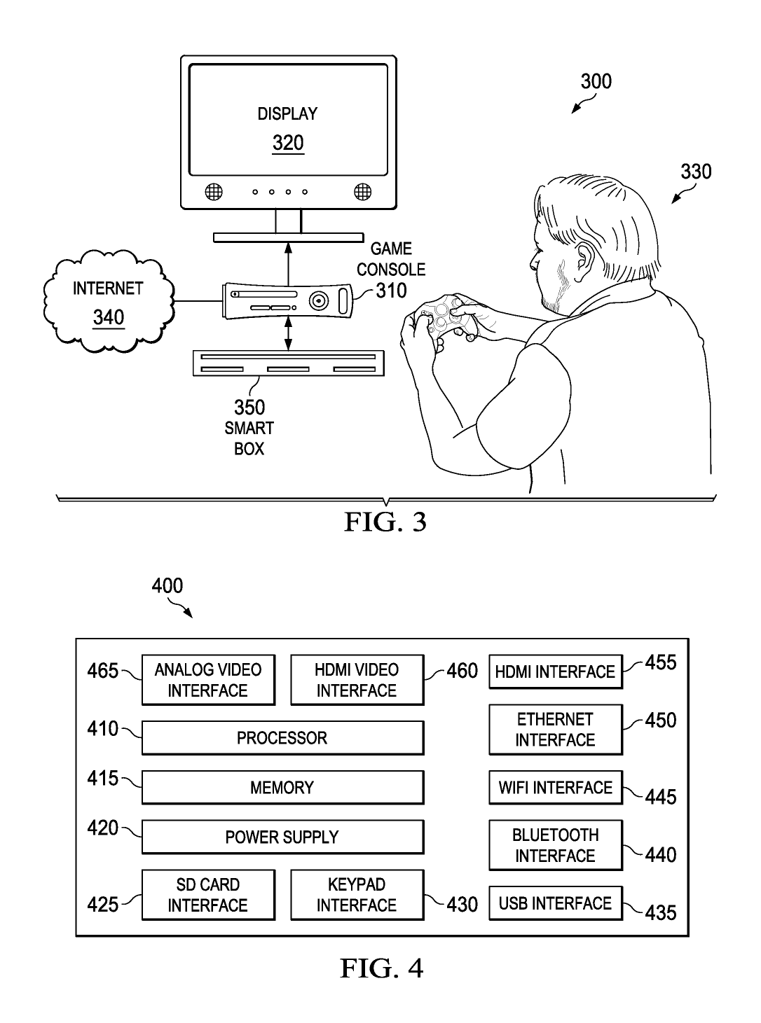

FIG. 3 provides system diagram 300 of an example embodiment of user 330 with game console 210 and video output 220. User 230 controls game console 310 with a controller which may be connected to game console 310 either wirelessly or through a wired connection. Game console 310 may be connected to the Internet or other network. Smart box 350 may also be connected to the same or different network as game console 310. In this example embodiment, smart box 350 is connected to game console 310 but not to display 320. In this example embodiment, smart box 350 controls game console 310, for example, by instructing game console 310 to pause its output, without smart box 350 interrupting the output between game console 310 and display 320. At a time configurable by an administrator, smart box 310 interrupts the video feed between game console 310 and display 320 and presents a task to user 330.

In an example embodiment, the controller is connected to smart box 350. A special controller is used that only works through gaming console 350 and does not interface directly with game console 310. If the user unplugs smart box 350, the controller no longer works and game console 310 is unusable. Alternatively, Game console 310 may configured such that it is only usable if smart box 350 is connected.

FIG. 4 provides system diagram 400 of an example embodiment of the control system of a smart box. The smart box may include one or more of processor 410, memory 415, power supply 420, SD card interface 425, keypad interface 430, USB interface 435, Bluetooth interface 440, WiFi interface 445, and Ethernet interface 450. Processor 410 may run instructions stored in memory 415. And the user may interface with processor 410 through one or more of SD card interface 425, keypad interface 430, USB interface 435, Bluetooth interface 440, WiFi interface 445, and Ethernet interface 450, among others as non-limiting examples. The smart box may also include one or more of HDMI interface 455, HDMI video interface 460, and analog video interface 465, among other video interfaces to interface with a display. The display, for example, may be integrated on the smart box and may provide the task, or the display may be the display used by the game console on which the user is playing the game.

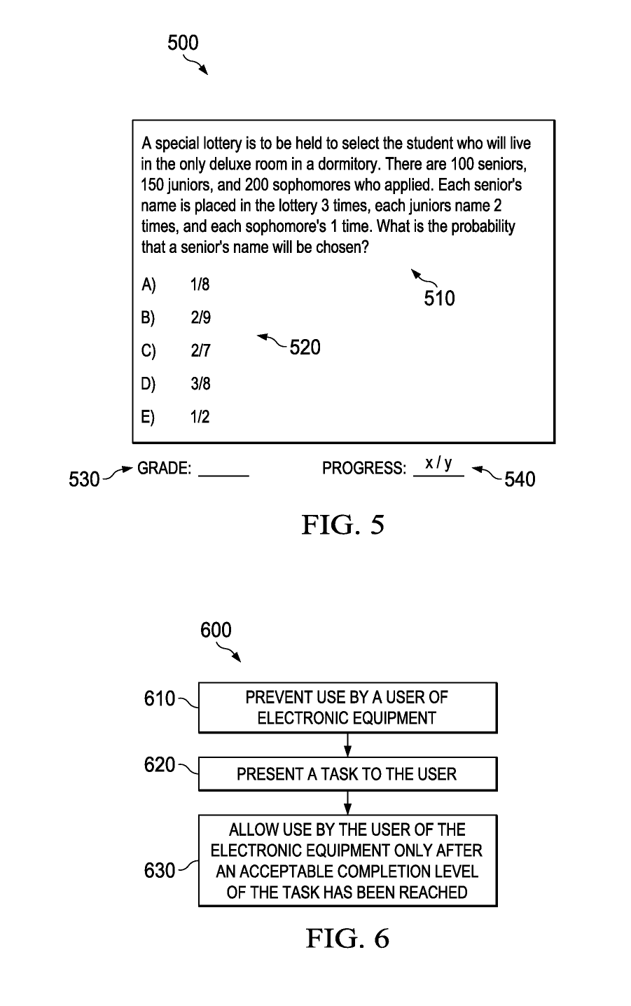

FIG. 5 provides diagram 500 of an example embodiment of a display of a task to be completed. Task 510 provides a math question to be solved with answers 520 given in multiple choice format. Answers 520 may also be received in true/false, short answer, or other format as non-limiting examples. Answer tabulator 520 may keep an updated score and may be presented as a percentage, as a fraction, and as a number of correct answers, as non-limiting examples. Progress tabulator 540 may keep an updated progress of answered questions or tasks and may be presented as a percentage and as a fraction as non-limiting examples. The values of answer tabulator 530 and progress tabulator 540 may be compared to a predetermined acceptable completion criteria for determining whether the user can continue the use of the electronic equipment.

FIG. 6 provides flow chart 600 of an example embodiment of a method of electronic equipment regulation. In block 610, use by a user of electronic equipment is prevented. In block 620, a task is presented to the user. In block 630, use by the user of the electronic equipment is allowed only after an acceptable completion level of the task has been reached.

The flow chart of FIG. 6 shows the architecture, functionality, and operation of a possible implementation of the electronic equipment regulation software. In this regard, each block represents a module, segment, or portion of code, which comprises one or more executable instructions for implementing the specified logical function(s). It should also be noted that in some alternative implementations, the functions noted in the blocks may occur out of the order noted in FIG. 5. For example, two blocks shown in succession in FIG. 5 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

Therefore, at least the following is claimed:

1. A system comprising:
a smart module comprising a processor configured:
to interface with electronic equipment;
to present a task to a user of the electronic equipment; and
to prevent use of the electronic equipment until the task is completed.

2. The system of claim 1, wherein the task comprises a question related to a school subject of the user.

3. The system of claim 2, wherein the question is presented in a display connected to the electronic equipment.

4. The system of claim 1, wherein the electronic equipment is at least one of a gaming system, a personal computer, a tablet, a laptop, and a cell phone.

5. The system of claim 1, wherein the smart module is physically connected to the electronic equipment.

6. The system of claim 1, wherein the smart module is wirelessly connected to the electronic equipment.

7. The system of claim 1, wherein the smart module comprises at least one of software, hardware, and firmware installed on the electronic equipment.

8. The system of claim 1, wherein preventing the use of the electronic equipment comprises pausing the activity being performed on the electronic equipment.

9. The system of claim 1, wherein preventing the use of the electronic equipment comprises interrupting a video output on the electronic equipment.

10. The system of claim 1, wherein the smart module is configured by an administrator who configures at least one of a password, timing consequence, task to be completed, and acceptable completion criteria.

11. The system of claim 1, wherein the smart module is further configured to present an advertisement with the presentation of the task.

12. The system of claim 1, further comprising the electronic equipment.

13. A method comprising:
preventing use by a user of electronic equipment;
presenting a task to the user; and
allowing use by the user of the electronic equipment only after an acceptable completion level of the task has been reached.

14. The method of claim 13, wherein the electronic equipment comprises at least one of a gaming system, a personal computer, a tablet, a laptop, and a cell phone.

15. The method of claim 13, wherein the task comprises a question related to a school subject of the user.

16. The method of claim 13, wherein preventing the use of the electronic equipment comprises pausing the activity being performed on the electronic equipment.

17. The method of claim 13, wherein preventing the use of the electronic equipment comprises interrupting a video output on the electronic equipment.

18. A non-transitory computer readable medium comprising software comprising instructions for:
preventing use by a user of electronic equipment;
presenting a task to the user; and
allowing use by the user of the electronic equipment only after an acceptable completion level of the task has been reached.

19. The computer readable medium of claim 18, wherein the electronic equipment comprises at least one of a gaming system, a personal computer, a tablet, a laptop, and a cell phone.

20. The computer readable medium of claim 18, wherein the task comprises a question related to a school subject of the user.
